(19) United States
(12) Patent Application Publication
(10) Pub. No.: US 2025/0136796 A1
(43) Pub. Date: May 1, 2025

(54) RUBBER COMPOSITION AND TIRE

(71) Applicant: Toyo Tire Corporation, Itami-shi (JP)

(72) Inventor: Tatsuya Endo, Itami-shi (JP)

(73) Assignee: Toyo Tire Corporation, Itami-shi (JP)

(21) Appl. No.: 18/909,148

(22) Filed: Oct. 8, 2024

(30) Foreign Application Priority Data
Oct. 26, 2023 (JP) 2023-183703

(51) Int. Cl. C08L 15/00; B60C 1/00

(52) U.S. Cl. CPC C08L 15/00; B60C 1/0016

(57) ABSTRACT

A rubber composition according to an embodiment includes a diene rubber, silica, and a silane-modified resin. The silane-modified resin is a resin bearing an alkoxysilyl group as a modifying group and having a tensile modulus of 700 to 1,200 MPa and a melting temperature Tm of 110 to 140° C., and a silane-modified polyethylene is preferably used as the silane-modified resin, for example.

### BACKGROUND OF THE INVENTION

### 1. Field of the Invention

The present invention relates to a rubber composition and also to a tire using the same.

### 2. Description of Related Art

Incorporating a resin, such as polyethylene, into a rubber composition containing a diene rubber is known. For example, JP2019-14856A describes that low-density polyethylene having a density of 0.910 g/cm³ or more and less than 0.940 g/cm³ and carbon black are incorporated into a rubber composition, thereby improving cut resistance and wear resistance.

JP2019-14857A describes that an ethylene-vinyl acetate copolymer and carbon black are incorporated into a rubber composition, thereby improving cut resistance.

WO2017/170839 describes that a silane-modified hydrocarbon resin is incorporated into a rubber composition, whereby excellent processability together with an excellent balance of rolling resistance and wet grip performance in tire applications can be obtained. The silane-modified hydrocarbon resin is obtained by modifying a hydrocarbon resin which contains 20 to 70 mass % of 1,3-pentadiene monomer units, 10 to 35 mass % of C₄₋₆ alicyclic monoolefin monomer units, and 3 to 30 mass % of C₄₋₈ acyclic monoolefin monomer units, with an organic silane compound.

### SUMMARY OF THE INVENTION

The elastic modulus of resins such as polyethylene is higher compared to the elastic modulus of general diene rubbers. Therefore, when such a resin with a high elastic modulus is added, the resulting rubber composition has increased strength. However, it has been found that upon deformation of the rubber composition, because there is no interaction between the diene rubber as a matrix and the filler, voids are created, and, therefore, the modulus of deformation is low, leading to a low tensile product due to the voids serving as breaking points.

Meanwhile, silica which is incorporated into rubber compositions has a strong tendency to aggregate, and, without the dispersing effect of a silane coupling agent, the tan δ around 0° C. is low. As a result, excellent wet grip performance is no longer exhibited.

In view of the above points, an object of an embodiment of the invention is to provide a rubber composition that is excellent in wet grip performance and also has high strength and a high tensile product.

The invention includes the following embodiments.

[1] A rubber composition including a diene rubber, silica, and a silane-modified resin bearing an alkoxysilyl group as a modifying group and having a tensile modulus of 700 to 1,200 MPa and a melting temperature Tm of 110 to 140° C.

[2] The rubber composition according to [1], in which the silane-modified resin is silane-modified polyethylene.

[3] The rubber composition according to [1] or [2], in which the amount of the silica is 30 to 150 parts by mass per 100 parts by mass of the diene rubber, and the amount of the silane-modified resin is 3 to 30 parts by mass per 100 parts by mass of the silica.

[4] The rubber composition according to any one of [1] to [3], further including a silane coupling agent, in which the mass ratio of the silane-modified resin to the silane coupling agent is 2/3 to 2/1.

[5] A tire obtained using the rubber composition according to any one of [1] to [4].

According to an embodiment of the invention, a rubber composition that is excellent in wet grip performance and also has high strength and a high tensile product can be provided.

### DESCRIPTION OF EMBODIMENTS

A rubber composition according to this embodiment includes a diene rubber as a rubber component, silica as a reinforcing filler, and also a silane-modified resin having a tensile modulus of 700 to 1,200 MPa and a melting temperature Tm of 110 to 140° C. Generally, the role of a silane compound in a silica-containing rubber composition is, first, to react with the silica surface to hydrophobize the silica, thereby improving the dispersibility of the silica. Such a rubber composition having high silica dispersibility can be provided with an increased tan δ around 0° C. and improved wet grip performance. The second role of a silane compound is to improve the interaction between the dispersed silica and the diene rubber as a matrix. For example, in a sulfide silane coupling agent which is often used in a rubber composition for tires, its sulfide moiety reacts with the double bond moiety of a diene rubber, thereby enhancing the interaction between the silica and the matrix rubber to increase the reinforcing properties as a rubber composition. Meanwhile, in the silane-modified resin according to this embodiment, its alkoxysilyl group reacts with silica, thereby improving the dispersibility of silica. In addition, although the resin has low reactivity with a diene rubber, it is in polymer form as a resin, has the above melting temperature, and thus is capable of melting into the matrix rubber. Therefore, the interaction between the silica and the matrix rubber can be enhanced to improve the reinforcing properties. Further, because the resin having a high elastic modulus is added as described above, the strength of the rubber composition can be enhanced. Therefore, according to this embodiment, a rubber composition having excellent wet grip performance due to improvement in the dispersibility of silica, together with high strength and a high tensile product, will be obtained.

In this embodiment, a diene rubber refers to a rubber with a repeating unit corresponding to a diene monomer having a conjugated double bond, and contains a carbon-carbon double bond in the polymer backbone. Specific examples of diene rubbers include various diene rubbers commonly used in rubber compositions, such as natural rubbers (NR), synthetic isoprene rubbers (IR), polybutadiene rubbers (BR), styrene butadiene rubbers (SBR), nitrile rubbers (NBR), chloroprene rubbers (CR), styrene-isoprene copolymer rubbers, butadiene-isoprene copolymer rubbers, and styrene-isoprene-butadiene copolymer rubbers. The concept of these diene rubbers also encompasses those modified at the terminal or backbone as necessary (e.g., terminally modified SBR) and those modified to impart desired characteristics (e.g., modified NR). Any one of these diene rubbers may be used, and it is also possible to use two or more kinds together.

In one embodiment, the diene rubber may include a styrene butadiene rubber. The styrene butadiene rubber may be a solution-polymerized styrene butadiene rubber (SSBR) or an emulsion-polymerized styrene butadiene rubber (ESBR). In addition, the styrene butadiene rubber may also be a modified styrene butadiene rubber (modified SBR) or an unmodified styrene butadiene rubber (unmodified SBR).

It is more preferable that the diene rubber includes a modified SBR (preferably modified SSBR) into which a functional group has been introduced. The functional group in the modified SBR preferably contains an oxygen atom and/or a nitrogen atom and may be, for example, at least one member selected from the group consisting of an amino group, a hydroxy group, an alkoxy group, an epoxy group, a silyl group, and a carboxy group. When such a modified SBR modified with a functional group is present, the dispersibility of silica as a filler can be improved.

In one embodiment, the amount of styrene butadiene rubber (preferably modified styrene butadiene rubber) in 100 parts by mass of the diene rubber is not particularly limited, but is preferably 50 parts by mass or more, more preferably 70 parts by mass or more, and still more preferably 80 parts by mass or more, and may also be 100 parts by mass.

As the silica in this embodiment, for example, wet silica and dry silica can be mentioned. It is preferable to use wet silica, such as wet-precipitated silica or wet-gelled silica.

The amount of silica per 100 parts by mass of the diene rubber is preferably 30 to 150 parts by mass, more preferably 35 to 120 parts by mass, more preferably 40 to 100 parts by mass, and still more preferably 45 to 80 parts by mass.

The reinforcing filler to be incorporated into the rubber composition may be silica alone, and it is also possible to incorporate carbon black together with silica. The reinforcing filler preferably contains silica in a proportion of 80 mass % or more, more preferably 90 mass % or more. The carbon black content is not particularly limited and may be, per 100 parts by mass of the diene rubber, 15 parts by mass or less, 10 parts by mass or less, 5 parts by mass or less, or 0 parts by mass.

As the silane-modified resin in this embodiment, a thermoplastic resin bearing an alkoxysilyl group as a modifying group and having a tensile modulus of 700 to 1,200 MPa and a melting temperature Tm of 110 to 140° C. is used.

When such a silane-modified resin is used, the alkoxysilyl group reacts with silanol groups on the silica surface, whereby the dispersibility of the silica can be improved. As alkoxysilyl groups, for example, trialkoxysilyl groups such as a trimethoxysilyl group and a triethoxysilyl group, alkyldialkoxysilyl groups such as a methyldimethoxysilyl group and an ethyldiethoxysilyl group, and dialkylalkoxysilyl groups such as a dimethylmethoxysilyl group and a diethylethoxysilyl group can be mentioned. Any one of them may be contained, and it is also possible that two or more kinds are contained. Among them, a trialkoxysilyl group is preferable.

A silane-modified resin bearing an alkoxysilyl group as a modifying group may be obtained, for example, by graft-introducing an alkoxysilane (e.g., vinylalkoxysilane) into a base resin to silane-modify the same. The silane-modified resin may also be, for example, a random copolymer of a monomer of the base resin and a vinylalkoxysilane. Silane modification by graft introduction can be performed according to a known technique, such as solution modification, melt modification, solid-phase modification by irradiation with an electron beam or ionizing radiation, or modification in a supercritical fluid, for example.

The alkoxysilyl group may be introduced at the terminal of the base resin, but is preferably introduced randomly into the backbone by the above graft introduction or random copolymerization.

Because the tensile modulus of the silane-modified resin is 700 MPa or more, the reinforcing effect can be enhanced. The tensile modulus of the silane-modified resin is more preferably 720 to 1,100 MPa, more preferably 750 to 1,000 MPa, and still more preferably 770 to 900 MPa.

As used herein, the tensile modulus of a silane-modified resin is the tensile modulus Et measured in accordance with JIS K7161-1:2014, and refers to the slope of a stress/strain curve between two strain points of ε1=0.05% and ε2=0.25%. In particular, the tensile modulus is measured by subjecting a test piece with a thickness of 4 mm and a width of 10 mm to a tensile test at a gauge length of 50 mm, a grip distance of 115 mm, and a test speed of 1 mm/min.

Because the melting temperature Tm is 140° C. or less, at the time of kneading the rubber composition, the silane-modified resin can melt and mix with the diene rubber forming a matrix. Because the melting temperature Tm is 110° C. or more, a decrease in the strength of the rubber composition after vulcanization during use can be suppressed. The melting temperature Tm of the silane-modified resin is preferably more than 110° C. and 135° C. or less, and still more preferably 115 to 130° C.

As used herein, the melting temperature Tm of a silane-modified resin is the melting peak temperature (Tpm), i.e., the temperature at the top of a melting peak, measured in accordance with JIS K7121-1987. In particular, by differential scanning calorimetry (heat flux method DSC), a sample is heated from −80° C. to 250° C. at 10° C./min to obtain a DSC curve, and the melting peak temperature is determined from the DSC curve. Incidentally, in the case where two or more melting peaks appear, the temperature at the top of the melting peak with the highest temperature is taken.

The base resin for the silane-modified resin is not particularly limited as long as it is a polymer that provides the silane-modified resin with a tensile modulus and a melting temperature Tm within the above numerical ranges, and polyethylene and terpene-based resins can be mentioned, for example.

A terpene-based resin is a resin obtained by polymerizing a terpene monomer such as α-pinene, β-pinene, limonene, or dipentene. Examples of terpene-based resins include polyterpene resins produced using a terpene monomer alone, as well as terpene phenol resins, aromatic modified terpene resins, and the like.

Polyethylene is preferable as a base resin for the silane-modified resin. That is, a silane-modified resin according to a preferred embodiment is silane-modified polyethylene. As the silane-modified polyethylene, for example, LINKLON®, a silane crosslinkable resin sold by Mitsubishi Chemical Corporation, is preferably used. Specifically, “LINKLON SH710N”, “LINKLON SL800N”, “LINKLON SS732N”, “LINKLON CF700N”, “LINKLON XCF710N”, “LINKLON XLE830N”, “LINKLON LE760N”, “LINKLON XHE740N”, “LINKLON HM600A”, and the like can be mentioned.

The density of the silane-modified polyethylene is not particularly limited and may be 0.85 to 0.96 g/cm³, for example, but is preferably 0.85 to 0.93 g/cm³, and more preferably 0.86 to 0.89 g/cm³. Here, the density is measured in accordance with JIS K7112:1999.

The amount of silane-modified resin (preferably silane-modified polyethylene) is, per 100 parts by mass of the silica, preferably 3 to 30 parts by mass, more preferably 5 to 25 parts by mass, and still more preferably 6 to 20 parts by mass. The amount of silane-modified resin per 100 parts by mass of the diene rubber is not particularly limited and may be, for example, 0.5 to 30 parts by mass, 1 to 20 parts by mass, or 2 to 15 parts by mass.

The rubber composition according to this embodiment may further incorporate a silane coupling agent. When a silane coupling agent is incorporated together with the silane-modified resin, the wet grip performance can be further improved. In this case, the amount of silane coupling agent is not particularly limited, but is, per 100 parts by mass of the silica, preferably 3 to 20 parts by mass, more preferably 4 to 15 parts by mass, and still more preferably 5 to 12 parts by mass.

From the viewpoint of the balance between wet grip performance, and strength and tensile product, it is preferable that the mass ratio of the silane-modified resin relative to the silane coupling agent (silane-modified resin amount/silane coupling agent amount) is 2/3 to 2/1. The mass ratio is more preferably 2/3 to 4/3.

As silane coupling agents, for example, sulfide silane coupling agents such as bis(3-triethoxysilylpropyl) tetrasulfide, bis(3-triethoxysilylpropyl) disulfide, bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide, mercaptosilane coupling agents such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethoxysilane, and thioester group-containing silane coupling agents such as 3-octanoylthio-1-propyltriethoxysilane, 3-propionylthiopropyltrimethoxysilane, 3-hexanoylthio-1-propyltriethoxysilane, and 3-octanoylthio-1-propyltrimethoxysilane can be mentioned. Any one of them can be used, and it is also possible to use a combination of two or more kinds.

In addition to the above components, the rubber composition according to this embodiment may also incorporate, as optional components, various additives generally used in rubber compositions, such as zinc oxide, stearic acid, oils, antioxidants, waxes, vulcanizing agents, and vulcanization accelerators, for example.

The zinc oxide content is not particularly limited and may be, for example, per 100 parts by mass of the diene rubber, 0 to 10 parts by mass, 0.5 to 5 parts by mass, or 1 to 4 parts by mass.

The stearic acid content is not particularly limited and may be, for example, per 100 parts by mass of the diene rubber, 0 to 10 parts by mass, 0.5 to 5 parts by mass, or 1 to 4 parts by mass.

The oil content is not particularly limited and may be, for example, per 100 parts by mass of the diene rubber, 0 to 40 parts by mass, 5 to 35 parts by mass, or 10 to 30 parts by mass.

As antioxidants, for example, amine-ketone-based, aromatic secondary amine-based, monophenol-based, bisphenol-based, benzimidazole-based, and like various antioxidants can be mentioned. Any one of them can be used, and it is also possible to use a combination of two or more kinds. The antioxidant content is not particularly limited and may be, for example, per 100 parts by mass of the diene rubber, 0 to 10 parts by mass, 0.5 to 5 parts by mass, or 1 to 4 parts by mass.

The wax content is not particularly limited and may be, for example, per 100 parts by mass of the diene rubber, 0 to 10 parts by mass, 0.5 to 5 parts by mass, or 1 to 4 parts by mass.

As a vulcanizing agent, sulfur is preferably used. The vulcanizing agent content is not particularly limited and may be, per 100 parts by mass of the diene rubber, 0.1 to 10 parts by mass, 0.5 to 5 parts by mass, or 1 to 3 parts by mass.

As vulcanization accelerators, for example, sulfenamide-based, guanidine-based, thiuram-based, thiazole-based, and like various vulcanization accelerators can be mentioned. Any one of them can be used alone, and it is also possible to use a combination of two or more kinds. The vulcanization accelerator content is not particularly limited, but is, per 100 parts by mass of the diene rubber, preferably 0.1 to 7 parts by mass, and more preferably 0.5 to 5 parts by mass, or may also be 1 to 4 parts by mass.

The rubber composition according to this embodiment can be made by kneading in the usual manner using a commonly used mixer, such as a Banbury mixer, a kneader, or a roll. That is, for example, in the first mixing stage (non-productive mixing process), additives other than a vulcanizing agent and a vulcanization accelerator are added to a diene rubber together with silica and a silane-modified resin and mixed. Next, in the final mixing stage (productive mixing process), a vulcanizing agent and a vulcanization accelerator are added to the obtained mixture and mixed. As a result, an unvulcanized rubber composition can be prepared. In the non-productive mixing process, in order to melt the silane-modified resin, the discharge temperature from the mixer is preferably 140° C. or more, and more preferably 150 to 170° C.

The rubber composition according to this embodiment can be used for various rubber members for tires, vibration-proof rubbers, conveyor belts, and the like. The rubber composition is preferably used for tires, and is applicable to various areas of a tire, such as the treads, sidewalls, and bead parts of pneumatic tires of various sizes for various applications, including tires for passenger cars, large-size tires for trucks and buses, and the like. Use in a tire tread is more preferable. That is, a tire according to one embodiment includes a tread rubber formed from the above rubber composition.

In one embodiment, a tire including a rubber portion (e.g., tread rubber, sidewall rubber, etc.) made of the above rubber composition is produced as follows. The rubber composition is formed into a predetermined shape in the usual manner, for example, by extrusion. The obtained formed product is combined with other parts to make a green tire. The green tire is vulcanization-molded at 140 to 180° C., for example, whereby a pneumatic tire can be produced.

### EXAMPLES

Examples will be shown hereinafter, but the invention is not limited to these examples.

Details of the raw materials used in the examples and comparative examples are as follows.
SBR: Terminally amine-modified SSBR, “HPR350” manufactured by ENEOS Materials Corporation
Silica: “Nipsil AQ” manufactured by Tosoh Silica Corporation
Zinc oxide: “Zinc Oxide No. 3” manufactured by Mitsui Mining & Smelting Co., Ltd.
Stearic acid: “LUNAC S-20” manufactured by Kao Corporation
Oil: “PROCESS NC-140” manufactured by JX Nippon Oil & Energy Corporation
Sulfur: “Powder Sulfur” manufactured by Tsurumi Chemical Industry Co., Ltd.
Vulcanization accelerator 1: “SOXINOL CZ” manufactured by Sumitomo Chemical Co., Ltd.
Vulcanization accelerator 2: “Nocceler D” manufactured by Ouchi Shinko Chemical Industrial Co., Ltd.
Silane coupling agent: Bis(3-triethoxysilylpropyl) disulfide, “Si75” manufactured by Evonik Japan Co., Ltd.
Propyltriethoxysilane: manufactured by Tokyo Chemical Industry Co., Ltd.
PE: Unmodified polyethylene, “UMERIT 0520F” manufactured by Ube-Maruzen Polyethylene Co., Ltd., (tensile modulus=870 MPa, melting temperature Tm=111° C.)
Silane-modified BR: Silane-modified liquid butadiene rubber, “GS-L-BR-114” manufactured by Kuraray Co., Ltd.
Silane-modified PP: Silane-modified polypropylene, “LINKLON PK500N” manufactured by Mitsubishi Chemical Corporation (tensile modulus=1,200 MPa, melting temperature Tm=210° C.)
Silane-modified PE 1: Triethoxysilyl group-modified polyethylene, “LINKLON SH710N” manufactured by Mitsubishi Chemical Corporation (density=0.89 g/cm³, tensile modulus=840 MPa, melting temperature Tm=120° C.)
Silane-modified PE 2: Triethoxysilyl group-modified polyethylene, “LINKLON SL800N” manufactured by Mitsubishi Chemical Corporation (density=0.87 g/cm³, tensile modulus=800 MPa, melting temperature Tm=120° C.)

The evaluation methods in the examples and comparative examples are as follows.

### (1) S100 and Tensile Product:

Using an autograph manufactured by Shimadzu Corporation, a 2-mm-thick vulcanized rubber sample was subjected to a tensile test (Dumbbell No. 3) in accordance with JIS K6251:2017 to measure the tensile strength (tensile speed=500 mm/min).

Then, the tensile stress S100 at 100% elongation was determined and expressed as an index taking the value of Comparative Example 1 in Table 1, the value of Comparative Example 5 in Table 2, the value of Comparative Example 7 in Table 3, the value of Comparative Example 8 in Table 4, the value of Comparative Example 12 in Table 5, and the value of Comparative Example 14 in Table 6, as 100. The larger the index, the higher the S100, indicating higher reinforcing properties.

In addition, the tensile strength at break Tb (MPa) and the elongation at break Eb (%) were determined, and the tensile product (Tb×Eb÷100) was calculated and expressed as an index taking the value of Comparative Example 1 in Table 1, the value of Comparative Example 5 in Table 2, the value of Comparative Example 7 in Table 3, the value of Comparative Example 8 in Table 4, the value of Comparative Example 12 in Table 5, and the value of Comparative Example 14 in Table 6, as 100. The larger the index, the higher the value of the tensile product, indicating higher durability.

### (2) 0° C. Tan δ:

Using a viscoelasticity tester manufactured by Ueshima Seisakusho Co., Ltd., a 2-mm-thick vulcanized rubber sample was subjected to a viscoelasticity test in tensile mode at a frequency of 10 Hz, a static strain of 10%, a dynamic strain of 1%, and a temperature of 0° C. to measure the loss factor tan δ. The result was then expressed as an index taking the tan δ of Comparative Example 1 in Table 1, the tan δ of Comparative Example 5 in Table 2, the tan δ of Comparative Example 7 in Table 3, the tan δ of Comparative Example 8 in Table 4, the tan δ of Comparative Example 12 in Table 5, and the tan δ of Comparative Example 14 in Table 6, as 100. The larger the index, the larger the tan δ, that is, the higher the energy loss, indicating better wet grip performance as a tire.

### First Experiment Example

According to the formulations (parts by mass) shown in Table 1 below, using a lab mixer (300 cc) manufactured by Daihan Co. Ltd., a diene rubber was masticated for 30 seconds, and then components except for sulfur and a vulcanization accelerator were added, the resultant mixture was kneaded for 240 seconds, and then discharged (discharge temperature=170° C.). Next, the discharged rubber composition was fed to the lab mixer, kneaded for 180 seconds, and then discharged (discharge temperature=165° C.). Further, the discharged rubber composition, sulfur, and a vulcanization accelerator were fed to the lab mixer and kneaded for 60 seconds (discharge temperature=105° C.) to prepare unvulcanized rubber compositions of Comparative Examples 1 to 4 and Examples 1 and 2. Using two rolls, each obtained rubber composition was sheeted to a thickness of 2 mm and then vulcanization-pressed at 160° C. for 20 minutes, thereby giving a vulcanized rubber sample. The obtained vulcanized rubber samples were evaluated for S100, tensile product, and 0° C. tan δ.

The results are as shown in Table 1 below. Comparative Example 1 is an example where low-molecular-weight silane was used as a silica dispersant. In Comparative Example 1, due to the improved dispersibility of silica, the 0° C. tan δ was high, and the wet grip performance was excellent, but the tensile stress S100 and the tensile product were low.

Comparative Example 2 is an example where PE, that is, non-silane-modified polyethylene, was incorporated. In this case, because polyethylene is harder than a diene rubber, the tensile stress S100 improved, but the 0° C. tan δ and the tensile product decreased.

Comparative Example 3 is an example where silane-modified BR was incorporated. Silane-modified BR is a liquid rubber at room temperature. Accordingly, its melting temperature Tm is lower than room temperature, also its original shape is not retained, and thus the tensile modulus is unmeasurable. In Comparative Example 3, because of the excellent flexibility and low-temperature characteristics peculiar to a butadiene rubber, the tensile product was high, and the 0° C. tan δ was also good. However, because the inherent elastic modulus of silane-modified BR is lower than that of the matrix rubber, compared to Comparative Example 1, the tensile stress S100 in Comparative Example 3 decreased, resulting in inferior reinforcing properties.

Comparative Example 4 is an example where silane-modified PP was incorporated. The silane-modified PP has a high melting temperature, and thus did not melt when kneaded with the diene rubber and remained as raw material pellets, making it impossible to make a uniform rubber sheet. Therefore, the above physical property measurement and evaluation were not performed.

In contrast, in Examples 1 and 2 where silane-modified PE 1 or 2 having a predetermined tensile modulus and melting temperature Tm was used, compared to Comparative Example 1, while having the same or better 0° C. tan δ (wet grip performance), the tensile stress S100 and the tensile product improved, resulting in excellent reinforcing properties and durability.

TABLE 1

| | Comp. | Comp. | Comp. | Comp. | | |
|---|---|---|---|---|---|---|
| | Ex. 1 | Ex. 2 | Ex. 3 | Ex. 4 | Ex. 1 | Ex. 2 |
| Formulation (parts | | | | | | |
| by mass) | | | | | | |
| SBR | 100 | 100 | 100 | 100 | 100 | 100 |
| Silica | 50 | 50 | 50 | 50 | 50 | 50 |
| Zinc oxide | 2 | 2 | 2 | 2 | 2 | 2 |
| Stearic acid | 2 | 2 | 2 | 2 | 2 | 2 |
| Propyltri- | 4 | | | | | |
| ethoxysilane | | | | | | |
| PE | | 4 | | | | |
| Silane-modified BR | | | 4 | | | |
| Silane-modified PP | | | | 4 | | |
| Silane-modified PE | | | | | 4 | |
| 1 | | | | | | |
| Silane-modified PE | | | | | | 4 |
| 2 | | | | | | |
| Oil | 10 | 10 | 10 | 10 | 10 | 10 |
| Sulfur | 2 | 2 | 2 | 2 | 2 | 2 |
| Vulcanization | 1.5 | 1.5 | 1.5 | 1.5 | 1.5 | 1.5 |
| accelerator 1 | | | | | | |
| Vulcanization | 1.5 | 1.5 | 1.5 | 1.5 | 1.5 | 1.5 |
| accelerator 2 | | | | | | |
| Evaluation (index) | | | | | | |
| S100 | 100 | 148 | 89 | — | 146 | 142 |
| Tensile product | 100 | 95 | 124 | — | 105 | 108 |
| 0° C. tan δ | 100 | 96 | 121 | — | 103 | 108 |

### Second Experiment Example

In the same manner as in first experiment example except for following the formulations (parts by mass) shown in Table 2 below, rubber compositions of Comparative Examples 5 and 6 and Example 3 were prepared. Vulcanized rubber samples were made using the obtained rubber compositions, and the S100, tensile product, and 0° C. tan δ were evaluated.

The results are as shown in Table 2 below. Even when the amount of silane compound incorporated was increased, the same effects as in the first experimental example were confirmed. That is, compared to Comparative Example 5 where low-molecular-weight silane was used, in Comparative Example 6 where non-silane-modified PE was used, although the tensile stress S100 improved, the 0° C. tan δ decreased. In contrast, in Example 3 where silane-modified PE was used, compared to Comparative Example 5, while further improving the excellent 0° C. tan δ (wet grip performance), the tensile stress S100 and the tensile product significantly improved, resulting in excellent reinforcing properties and durability.

TABLE 2

| | Comp. Ex. 5 | Comp. Ex. 6 | Ex. 3 |
|---|---|---|---|
| Formulation (parts by mass) | | | |
| SBR | 100 | 100 | 100 |
| Silica | 50 | 50 | 50 |
| Zinc oxide | 2 | 2 | 2 |
| Stearic acid | 2 | 2 | 2 |
| Propyltriethoxysilane | 12 | | |
| PE | | 12 | |
| Silane-modified PE 1 | | | 12 |
| Oil | 10 | 10 | 10 |
| Sulfur | 2 | 2 | 2 |
| Vulcanization accelerator 1 | 1.5 | 1.5 | 1.5 |
| Vulcanization accelerator 2 | 1.5 | 1.5 | 1.5 |
| Evaluation (index) | | | |
| S100 | 100 | 202 | 182 |
| Tensile product | 100 | 103 | 110 |
| 0° C. tan δ | 100 | 98 | 113 |

### Third Experiment Example

In the same manner as in first experiment example except for following the formulations (parts by mass) shown in Table 3 below, rubber compositions of Comparative Example 7 and Example 4 were prepared. Vulcanized rubber samples were made using the obtained rubber compositions, and the S100, tensile product, and 0° C. tan δ were evaluated.

The results are as shown in Table 3 below. In the case where the amount of silica was reduced to 30 parts by mass, the effects decreased. However, compared to Comparative Example 7 where low-molecular-weight silane was used, in Example 4 where silane-modified PE was used, while maintaining or improving the excellent 0° C. tan δ (wet grip performance), the tensile stress S100 and the tensile product improved.

TABLE 3

| | Comp. Ex. 7 | Ex. 4 |
|---|---|---|
| Formulation (parts by mass) | | |
| SBR | 100 | 100 |
| Silica | 30 | 30 |
| Zinc oxide | 2 | 2 |
| Stearic acid | 2 | 2 |
| Propyltriethoxysilane | 2.4 | |
| Silane-modified PE 1 | | 2.4 |
| Oil | 10 | 10 |
| Sulfur | 2 | 2 |
| Vulcanization accelerator 1 | 1.5 | 1.5 |
| Vulcanization accelerator 2 | 1.5 | 1.5 |
| Evaluation (index) | | |
| S100 | 100 | 103 |
| Tensile product | 100 | 106 |
| 0° C. tan δ | 100 | 102 |

### Fourth Experiment Example

In the same manner as in first experiment example except for following the formulations (parts by mass) shown in Table 4 below, rubber compositions of Comparative Examples 8 to 11 and Examples 5 and 6 were prepared. Vulcanized rubber samples were made using the obtained rubber compositions, and the S100, tensile product, and 0° C. tan δ were evaluated.

The results are as shown in Table 4 below. Even when the amount of silica was increased to 75 parts by mass, the same effects as in the first experimental example were confirmed. That is, compared to Comparative Example 8 where low-molecular-weight silane was used, in Comparative Example 9 where non-silane-modified PE was used, although the tensile stress S100 improved, the tensile product and the 0° C. tan δ decreased. In addition, in Comparative Example 10 where silane-modified BR was incorporated, although the tensile product and the 0° C. tan δ improved, the tensile stress S100 decreased, resulting in inferior reinforcing properties. In Comparative Example 11 where silane-modified PP was incorporated, it was not possible to make a uniform rubber sheet. In contrast, in Examples 5 and 6 where silane-modified PE 1 or 2 was used, compared to Comparative Example 8, while further improving the excellent 0° C. tan δ (wet grip performance), the tensile stress S100 and the tensile product improved, resulting in excellent reinforcing properties and durability.

TABLE 4

| | Comp. | Comp. | Comp. | Comp. | | |
|---|---|---|---|---|---|---|
| | Ex. 8 | Ex. 9 | Ex. 10 | Ex. 11 | Ex. 5 | Ex. 6 |
| Formulation (parts | | | | | | |
| by mass) | | | | | | |
| SBR | 100 | 100 | 100 | 100 | 100 | 100 |
| Silica | 75 | 75 | 75 | 75 | 75 | 75 |
| Zinc oxide | 2 | 2 | 2 | 2 | 2 | 2 |
| Stearic acid | 2 | 2 | 2 | 2 | 2 | 2 |
| Propyltri- | 6 | | | | | |
| ethoxysilane | | | | | | |
| PE | | 6 | | | | |
| Silane-modified BR | | | 6 | | | |
| Silane-modified PP | | | | 6 | | |
| Silane-modified PE | | | | | 6 | |
| 1 | | | | | | |
| Silane-modified PE | | | | | | 6 |
| 2 | | | | | | |
| Oil | 10 | 10 | 10 | 10 | 10 | 10 |
| Sulfur | 2 | 2 | 2 | 2 | 2 | 2 |
| Vulcanization | 1.5 | 1.5 | 1.5 | 1.5 | 1.5 | 1.5 |
| accelerator 1 | | | | | | |
| Vulcanization | 1.5 | 1.5 | 1.5 | 1.5 | 1.5 | 1.5 |
| accelerator 2 | | | | | | |
| Evaluation (index) | | | | | | |
| S100 | 100 | 162 | 75 | — | 171 | 162 |
| Tensile product | 100 | 97 | 114 | — | 110 | 118 |
| 0° C. tan δ | 100 | 99 | 135 | — | 105 | 116 |

### Fifth Experiment Example

In the same manner as in first experiment example except for following the formulations (parts by mass) shown in Table 5 below, rubber compositions of Comparative Examples 12 and 13 and Examples 7 and 8 were prepared. Vulcanized rubber samples were made using the obtained rubber compositions, and the S100, tensile product, and 0° C. tan δ were evaluated.

The results are as shown in Table 5 below. Even in the system where a silane coupling agent was used together, the same effects as in the first experimental example were confirmed. That is, compared to Comparative Example 12 where low-molecular-weight silane was used together with a silane coupling agent, in Comparative Example 13 where non-silane-modified PE was used together with a silane coupling agent, although the tensile stress S100 improved, the tensile product and the 0° C. tan δ decreased. In contrast, in Examples 7 and 8 where silane-modified PE 1 or 2 was used together with a silane coupling agent, compared to Comparative Example 12, while maintaining the excellent 0° C. tan δ (wet grip performance), the tensile stress S100 and the tensile product improved, resulting in excellent reinforcing properties and durability.

TABLE 5

| | Comp. | Comp. | | |
|---|---|---|---|---|
| | Ex. 12 | Ex. 13 | Ex. 7 | Ex. 8 |
| Formulation (parts by mass) | | | | |
| SBR | 100 | 100 | 100 | 100 |
| Silica | 50 | 50 | 50 | 50 |
| Zinc oxide | 2 | 2 | 2 | 2 |
| Stearic acid | 2 | 2 | 2 | 2 |
| Silane coupling agent | 3 | 3 | 3 | 3 |
| Propyltriethoxysilane | 3 | | | |
| PE | | 3 | | |
| Silane-modified PE 1 | | | 3 | |
| Silane-modified PE 2 | | | | 3 |
| Oil | 10 | 10 | 10 | 10 |
| Sulfur | 2 | 2 | 2 | 2 |
| Vulcanization accelerator 1 | 1.5 | 1.5 | 1.5 | 1.5 |
| Vulcanization accelerator 2 | 1.5 | 1.5 | 1.5 | 1.5 |
| Evaluation (index) | | | | |
| S100 | 100 | 106 | 108 | 114 |
| Tensile product | 100 | 99 | 117 | 106 |
| 0° C. tan δ | 100 | 95 | 101 | 100 |

### Sixth Experiment Example

In the same manner as in first experiment example except for following the formulations (parts by mass) shown in Table 6 below, rubber compositions of Comparative Example 14 and Examples 9 to 12 were prepared. Vulcanized rubber samples were made using the obtained rubber compositions, and the S100, tensile product, and 0° C. tan δ were evaluated.

The results are as shown in Table 6 below. In Examples 9 to 12, in a system where a silane coupling agent and silane-modified PE 1 or 2 were used together, their mass ratio was varied. In Examples 9 to 12, compared to Comparative Example 14 where silane-modified PE was not incorporated, while improving the 0° C. tan δ (wet grip performance), the tensile stress S100 and the tensile product improved. Particularly in Examples 9 and 10 where the silane-modified PE mass ratio was high, the tensile stress improving effect was high, and in Examples 11 and 12 where the silane coupling agent mass ratio was high, the improving effects on tensile product and 0° C. tan δ were high.

TABLE 6

| | Comp. | | | | |
|---|---|---|---|---|---|
| | Ex. 14 | Ex. 9 | Ex. 10 | Ex. 11 | Ex. 12 |
| Formulation | | | | | |
| (parts by mass) | | | | | |
| SBR | 100 | 100 | 100 | 100 | 100 |
| Silica | 75 | 75 | 75 | 75 | 75 |
| Zinc oxide | 2 | 2 | 2 | 2 | 2 |
| Stearic acid | 2 | 2 | 2 | 2 | 2 |
| Silane coupling Agent | 6 | 6 | 6 | 6 | 6 |
| Silane-modified PE 1 | | 8 | | 4.1 | |
| Silane-modified PE 2 | | | 8 | | 4.1 |
| Sulfur | 2 | 2 | 2 | 2 | 2 |
| Vulcanization | 1.5 | 1.5 | 1.5 | 1.5 | 1.5 |
| accelerator 1 | | | | | |
| Vulcanization | 1.5 | 1.5 | 1.5 | 1.5 | 1.5 |
| accelerator 2 | | | | | |
| Evaluation (index) | | | | | |
| S100 | 100 | 123 | 128 | 115 | 112 |
| Tensile product | 100 | 105 | 103 | 117 | 121 |
| 0° C. tan δ | 100 | 109 | 114 | 120 | 121 |
| Silane-modified | — | 1/0.75 | 1/0.75 | 1/1.46 | 1/1.46 |
| PE/coupling agent | | | | | |

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

What is claimed is:

1. A rubber composition comprising:
a diene rubber;
silica; and
a silane-modified resin bearing an alkoxysilyl group as a modifying group and having a tensile modulus of 700 to 1,200 MPa and a melting temperature Tm of 110 to 140° C.

2. The rubber composition according to claim 1, wherein the silane-modified resin is silane-modified polyethylene.

3. The rubber composition according to claim 1, wherein the amount of the silica is 30 to 150 parts by mass per 100 parts by mass of the diene rubber, and the amount of the silane-modified resin is 3 to 30 parts by mass per 100 parts by mass of the silica.

4. The rubber composition according to claim 1 further comprising a silane coupling agent, wherein the mass ratio of the silane-modified resin to the silane coupling agent is 2/3 to 2/1.

5. The rubber composition according to claim 1, wherein the diene rubber includes a styrene butadiene rubber.

6. The rubber composition according to claim 1, wherein the diene rubber includes a modified styrene butadiene rubber into which a functional group has been introduced.

7. The rubber composition according to claim 2, wherein the silane-modified polyethylene has a density of 0.85 to 0.93 g/cm³.

8. A tire obtained using the rubber composition according to claim 1.
